(19) United States
(12) Patent Application Publication
(10) Pub. No.: US 2012/0018417 A1
(43) Pub. Date: Jan. 26, 2012

(54) MULTIPLE-IN-ONE HEATING UNIT

(75) Inventors: Shu Chen, Zhongshan (CN); Shimin Luo, Wilmington, DE (US)

(73) Assignee: AMERICAN HOMETEC, INC., Wilmington, DE (US)

(21) Appl. No.: 13/009,099

(22) Filed: Jan. 19, 2011

Related U.S. Application Data
(60) Provisional application No. 61/296,205, filed on Jan. 19, 2010.

(51) Int. Cl. F24H 1/10; H05B 3/02; F24H 9/20

(52) U.S. Cl. 219/482; 392/465; 392/466

(57) ABSTRACT

A multiple-in-one heating unit is provided with a means to set a power capacity level from one of multiple choices at which a circuit board draws input power thereby establishing an output power level from the circuit board to generate a prescribed heat capacity. For example, for a 3-in-1 heating unit, the power capacity level is set by a 3-in-1 DIP Switch which can furnish one of three different signals (e.g., PA0, PA1, and PA2) to a control chip. The control chip will manage a relay group or another type component signaling for generating one of three different capacity outputs.

### CROSS-REFERENCE TO RELATED APPLICATIONS

This application claims priority to provisional U.S. patent application entitled, MULTIPLE-IN-ONE HEATING UNIT filed Jan. 19, 2010, having a Ser. No. 61/296,205, the disclosure of which is hereby incorporated by reference in its entirety.

### TECHNICAL FIELD

The invention relates generally to a system and method for a heater and, more particularly, to a system and method for providing multiple power capacities from a consolidated heating system.

### BACKGROUND OF THE INVENTION

Tankless water heaters have been developed in recent years and are known by a variety of names, including instantaneous, combination or “combi” boilers, continuous flow, inline, flash, or on-demand water heaters. This type of water heater is gaining in popularity mainly for space-saving and energy efficiency reasons. These advantages are achieved by heating water as it flows through the unit. This can create cost savings by not having to maintain heated water when it is not in use as is done with tank-type water heaters.

As a practical matter, tankless water heaters may be installed throughout a household at various points-of-use (POU) or at a centralized location. They also can be used alone or in combination with a centrally located water heater. In some cases, larger tankless models may be used to provide the hot water requirements, for example, in an entire house. Whether installed at one or multiple POUs, tankless water heaters provide a continuous flow of hot water and energy savings compared with tank-type heaters, which are only able to provide a finite supply of hot water limited by tank size and hot water recovery rates.

Tankless water heaters can generate a high amount of kilowatt (kw) energy to achieve desired water temperature(s). High kilowatt electric water heaters have the advantage(s) of achieving high energy efficiencies, saving energy consumption and saving space. In an effort to provide heated water, for example, in construction-type applications, heating units have been implemented to supply heated water in a variety of applications. Typically one heat unit, or heater, has a maximum power capacity for heating and supplying enough water in a specifically prescribed environment. Manufacturers may produce different models of heaters to accommodate a need for providing various power capacities based upon different applications or requirements.

In some situations, different power requirements are needed to satisfy certain circumstances, for example, requiring a specific power capacity value or range from a heater at a preferred level. This level may vary depending on a particular application, such as a requirement to provide heated water to multiple components including, for examples, sinks, showers, bath tubs, etc. In some situations, the requirement may include a large office area requiring increased heating capacity, for example, to multiple components. In another situation, the requirement may include a small residential area and require less power for heated water supplied to one or more various components. In yet another example, the incoming water may already be at a higher temperature and require less heating of water supplied to additional components. And further, building code regulations may influence prescribed heating capacities for heating units utilized in an assortment of applications.

Consequently, the differences and regulations for producing various power requirements from conventional tankless water heaters generally results in the installation and use of multiple tankless water heater models for given applications. This aforementioned use of one or more tankless water heater models may be inefficient and waste environmental resources in an attempt to provide the necessary power requirements for prescribed applications. Thus, the usage of conventional tankless water heater models may also increase costs by requiring installation of various and/or multiple production models (including those costs associated with labor and associated multiple sets of components and parts required for installation). As more models are needed to satisfy various demands/applications to provide an assortment of power capacities, the result may lead to complicated production management and higher cost for maintaining and controlling quality control. Furthermore, there may also be higher costs and difficulties in providing field service(s) for servicing the wide-variety of heater models used for respective applications.

The present disclosure is directed towards overcoming one or more shortcomings set forth above. Thus, there remains a need in the art to provide a more efficient tankless water heating system and method for providing multiple power capacities from a consolidated heater.

### SUMMARY OF THE INVENTION

It is, therefore, one object of the present invention to overcome the deficiencies of the prior art and to provide a hydraulic heating apparatus comprising a control circuit for controlling an output power of the hydraulic heating apparatus. The hydraulic heating apparatus may further include a power control system electronically configured to the control circuit and a variable setting device for setting the output power of the hydraulic heating apparatus. In disclosed embodiments, the variable setting device is electronically configured to the control circuit.

In accordance with another disclosed exemplary embodiment, a hydraulic heating system may include a control circuit for controlling an output power of the hydraulic heating apparatus and a power control system electronically configured to the control circuit. The hydraulic heating system is may also include a power control system including an electronically coupled power supply, an electronically coupled one or more heating elements and a direct-current and AC power supply exchange circuit electronically configured to the control circuit. Additional aspects of the disclosed embodiment may include a variable setting device for setting the output power of the hydraulic heating apparatus, wherein the variable setting device is electronically configured to the control circuit.

In accordance with yet another disclosed exemplary embodiment, a method may include determining a desired outgoing water temperature supplied from the heating system, setting a level at which the hydraulic heating system draws input power to obtain the outgoing water temperature, and setting an output power level capacity based on the input power level.

In accordance with still another disclosed exemplary embodiment, a system for managing power of a hydraulic heating system may include a means for determining a desired outgoing water temperature supplied from the heating system, a means for setting a level at which the hydraulic heating system draws input power to obtain the outgoing water temperature, and a means for setting an output power level capacity based on the input power level.

### BRIEF DESCRIPTION OF THE DRAWINGS

FIG. 1 is a schematic internal illustration of a water heater according to an exemplary disclosed embodiment;

FIG. 2 illustrates a dip-switch according to an exemplary disclosed embodiment;

FIG. 3 illustrates an electric schematic diagram according to an exemplary disclosed embodiment.

### DETAILED DESCRIPTION OF THE INVENTION

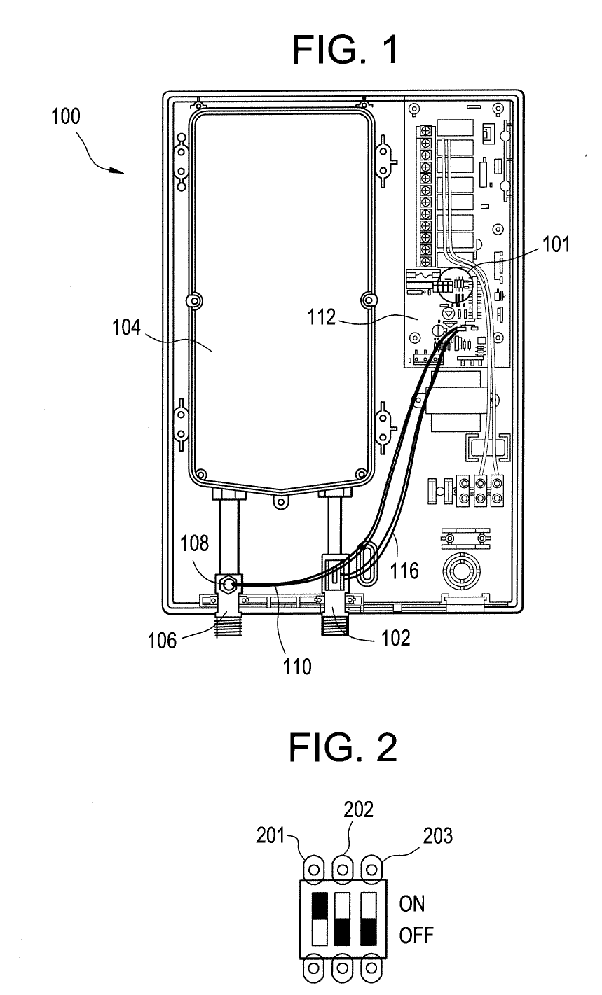

The invention will now be described with reference to the drawing figures, in which like reference numerals refer to like parts throughout. Referring to FIG. 1, an embodiment of a hydraulic heating system or water heating system 100 is provided illustrating internal components therein. For illustrative and discussion purposes, the present embodiment of the water heating system 100 is represented as a tankless water heater configuration. However, the invention is not limited to a tankless water heater configuration and may be applied to any variety of water heaters, boilers, and other hydraulic heating system.

The water heating system 100 includes a control system that manages power consumption of the water heater in order to accurately control output water temperature at a desired temperature level. Embodiments of the invention allow the water heating system 100 to more readily maintain a constant water temperature with or without changes in water flow. In addition the water heating system 100, of the described invention, also enables a desired water temperature to be achieved and maintained more quickly and accurately by use of the configuration of elements/components as described below.

The water heater system 100 may supply water via an inlet pipe 102 to a heat source 104 to heat the incoming water at a prescribed heating capacity. In one embodiment, the heat source 104 may include one or more heating elements to heat the water. Once heated, the water may be supplied via outlet pipe 106 to additional components such as one or more sinks, showers, bath tubs, or other devices requiring heated water. A thermal sensor 108 for reading/monitoring the temperature of the heated water may be configured such as via wire connects 110 to circuit board 112. A flow sensor 114 for reading/monitoring the flow of water supplied to heat source 104 may be configured such as via wire connects 116 to circuit board 112.

Circuit board 112 is provided to regulate the heat capacity of the heat source 104 based on prescribed settings of the circuit board. Circuit board 112 may include a master control electric circuit 16 electronically configured thereto and to various components of the water heating system 100. The master control electric circuit or power management circuit may include a logical circuitry configuration containing one or more combination of electrical components including, for example, TRIACs (silicon-controlled rectifier), relay(s), or a combination thereof. The amount and specification of electronic components is appropriately selected, at least, based upon the size of heating elements and/or heating requirements of the water heating system 100.

The power control system of water heating system 100 may preferably include an AC power supply and a direct-current and AC power supply exchange circuit electronically configured to the circuit board 112. In one embodiment, both the AC power supply and a direct-current and AC power supply exchange circuit are electronically connected to the master control electric circuit. An exemplary configuration of the disclosed invention may provide one or more heating elements of heat source 104 for heating water supplied thereto. The one or more heating elements may be arranged relative to the flow direction of water. Multiple heating elements may be arranged in serial, parallel, or a combination of serial and parallel connection-type configurations. Each heating element is preferably electronically connected to and controlled by the master control electric circuit of circuit board 112. Thus, the amount of power supplied to one or more heating elements is supplied by the AC power supply and regulated by the master control electric circuit. The power requirements of the water heating system 100 may increase gradually up to and including reaching the maximum power capacity depending on the system requirements as discussed below. The power requirements may also be set at any level below the maximum power capacity of the water heating system 100.

Additional embodiments of the invention may include a central processing unit (CPU) electronically configured to the master control electric circuit. A user operation interface circuit may be provided and electronically coupled to the master control electric circuit and CPU. In some disclosed embodiments, the user operation interface circuit may be configured to allow a user to manually set and/or adjust a prescribed temperature of the water heating system at a desired level.

A dip switch 101 may be electronically configured to circuit board 112 to set the power circuit of circuit board 112 to output a prescribed power output of the water heating system 100. Turning to FIG. 2, one disclosed embodiment of dip switch 101 is represented as a 3-in-1 DIP switch that can set three different signals (e.g., PA0, PA1, and PA2). Thus, the described configuration may be considered as a 3-in-1 unit having three capacities. In the illustration represented, switch 201 is set to “on,” and switches 202 and 203 are set to “off.” This setting may correspond to a first signal setting—PA0. This first setting may correspond to a first power capacity setting such as at 8.5 kilowatts. In another example, switch 202 may be set to “on,” and switches 201 and 203 are set to “off.” This setting may correspond to a second signal setting—PA2. This second setting may correspond to a second power capacity setting such as at 6.4 kilowatts. And, in a third example, switch 203 may be set to “on,” and switches 201 and 202 are set to “off.” This setting may correspond to a third signal setting—PA2. This third setting may correspond to a third power capacity setting such as at 4.3 kilowatts. Therefore, depending of the 3-in-1 DIP switch setting, multiple power capacities may be achieved in one heater unit to produce one of three power capacity settings of the circuit board 112.

In another embodiment, dip switch 101 may be replaced or supplemented with an electric circuit and accompanying software to set or select one of the multiple optional settings for certain parameter such as KW capacity of a water heater. This system can be can be repeated as desired, and can be implemented without changing hardware or software. The use of such a system allows the setting to be permanent, or at least, until the next change regardless, if power is connected or if the power is disrupted.

In a further embodiment, dip switch 101 may be replaced supplemented with a hardware component as a means to set or select one of the multiple optional settings for certain parameter, such as KW capacity of a water heater. For example, the hardware component can be, but should not be limited to, an electronic switch, a mechanical switch, a electronic knob, a mechanical knob, or other types of push buttons.

In yet another embodiment, dip switch 101 may be replaced or supplemented by recognition software as a means to set or select one of the multiple optional settings for certain parameter, such as KW capacity of a water heater. Recognition software can be realized by pressing a button, or buttons, by using signals sent from a remote control, or by other means that enables software to recognize the setting of the parameter from other forms of communication devices, such as a wireless PDA.

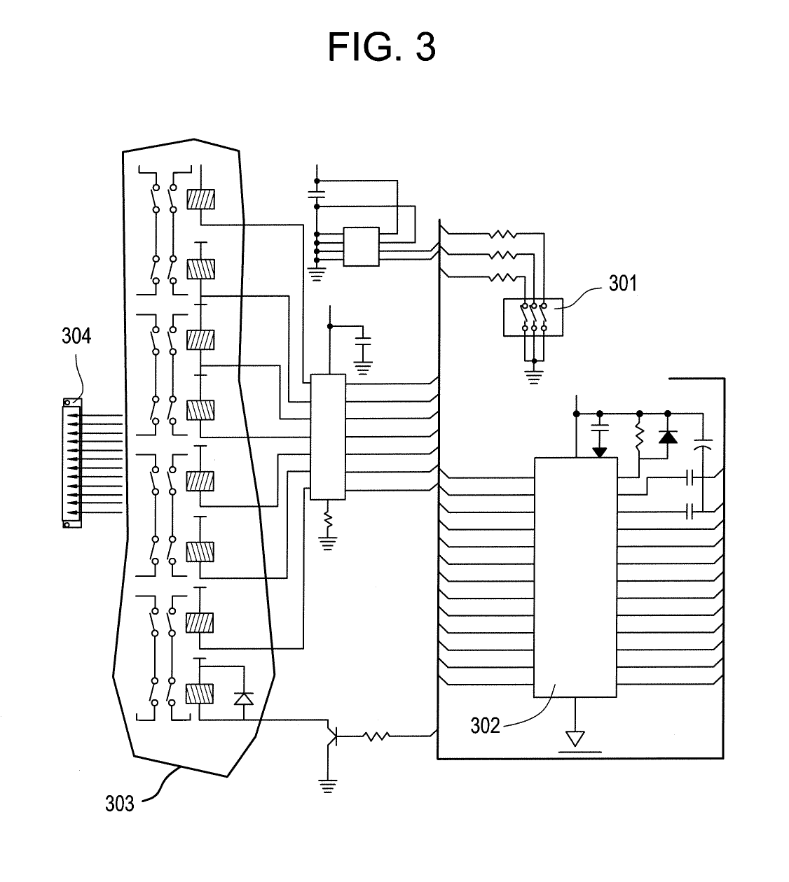

Turning to the electrical schematic diagram of FIG. 3, component 301 is a 3-in-1 DIP Switch that can be set to one of three different signals (e.g., PA0, PA1, and PA2) as discussed above. DIP Switch 301 is electronically configured to a control chip 302. A relay group 303 is provided and electronically coupled to DIP Switch 301. The relay group 303 assists in controlling/regulating the power provided to heat source 104 for heating the water. This may be accomplished, for example, by regulating the capacity output from the heating elements 304. Thus, the output power level capacity of the water heating system 100 may be regulated as a function of adjusting the capacity output from heating elements 304. While a certain plurality of heating elements 304 is shown in the drawings, as little as one or more heating elements 304 may be employed suitable for providing the necessary power for heating the water described herein.

Thus, in operation, the dip switch 101 sets the level at which that the circuit board 112 draws input power which, in turn, sets the output power level of the heat capacity based on the aforementioned input power. In the disclosed embodiment, the 3-in-1 DIP Switch 301 can furnish one of three different signals (e.g., PA0, PA1, PA2) to control chip 302 for controlling the relay group's 303 “open” and “close” signaling for generating one of three different capacity outputs from heating elements 304 in order to heat the water in the heater unit 100 at one of three different levels.

Thus, the disclosed invention provides the capability of allowing multiple power capacity settings in one heating unit. This, therefore, allows one heating unit to meet a variety of different applications/needs which would otherwise require multiple and/or various types of heating units/systems. Advantages provided by the disclosed invention, thereby, reduce manufacturing, field service and inventory carrying cost. In an event where the heating needs of an end user changes, the user will be able to readily utilize the same heater unit by setting the power capacity level of the heating unit to generate a desired heating level. Thus, by establishing a different power capacity level of the heating unit in accordance with disclosed aspects of the invention, one may avoid extra expenditures required for obtaining and installing alternate equipment for producing desired heating levels.

It will be apparent to those skilled in the art that various modifications and variations can be made in the disclosed apparatus and method without departing from the scope of the disclosure. For example, the disclosed control system and method used includes but is not limited to software, hardware and/or a combination of both. Furthermore, while a 3-in-1 DIP Switch has been described, in disclosed embodiments, to demonstrate a design for three capacities in one heating unit, additional and/or alternative dip switches or other switching mechanism may be used to control more or less electrical signals. Accordingly, different and/or multiple maximum capacities may be achieved in one heater unit. For example, disclosed embodiments of an alterative heater unit may have two maximum capacities (i.e., a 2-in-1 unit), three maximum capacities (a 3-in-1 unit), four maximum capacities (a 4-in-1 unit) etc.

While the invention has been described in the implementation of tankless water heater systems, other applications of the invention may be included in additional environments/apparatus, such as including other types of heaters (e.g., space heaters, etc.) and other kinds of equipment (e.g., air conditioners, etc.). While embodiments are described applicable to tankless water heaters, the system, described herein, may be employed in not only high efficiency electric water heaters, but also to additional systems including, for example, boilers and other residential, commercial, or industrial hydraulic heating systems. Additionally, other embodiments of the apparatus and method will be apparent to those skilled in the art from consideration of the specification. It is intended that the specification and examples be considered as exemplary only, with a true scope of the disclosure being indicated by the following claims and their equivalents.

What is claimed is:

1. A hydraulic heating apparatus comprising:
a control circuit for controlling an output power of the hydraulic heating apparatus;
a power control system electronically configured to the control circuit, said power control system including an electronically coupled power supply, and a direct-current and AC power supply exchange circuit electronically configured to the control circuit;
a heat source regulated by the power control system and electronically configured to the control circuit; and
a variable setting device for setting the output power of the hydraulic heating apparatus, said variable setting device electronically configured to said control circuit.

2. The hydraulic heating apparatus of claim 1, wherein the heat source comprises one or more heating elements.

3. The hydraulic heating apparatus of claim 1, wherein the control circuit comprises one or more operatively connected TRIACs (silicon-controlled rectifier), relay, or combination thereof.

4. The hydraulic heating apparatus of claim 1, wherein the variable setting device comprises a switching mechanism for controlling electrical signals.

5. The hydraulic heating apparatus of claim 1, wherein the variable setting device comprises a dip switch for setting the level at which the control circuit draws input power.

6. The hydraulic heating apparatus of claim 1, wherein the heating apparatus comprises one of a tankless water heater and a boiler.

7. A hydraulic heating system comprising:
a control circuit for controlling an output power of the hydraulic heating apparatus;
a power control system electronically configured to the control circuit, said power control system including an electronically coupled power supply, an electronically coupled one or more heating elements and a direct-current and AC power supply exchange circuit electronically configured to the control circuit; and
a variable setting device for setting the output power of the hydraulic heating apparatus, said variable setting device electronically configured to said control circuit.

8. The system of claim 7, wherein the control circuit comprises one or more operatively connected TRIACs (silicon-controlled rectifier), relay, or combination thereof.

9. The system of claim 7, wherein the variable setting device comprises a switching mechanism for controlling electrical signals.

10. The system of claim 7, wherein the variable setting device comprises a dip switch for setting the level at which the control circuit draws input power.

11. The system of claim 7, wherein the heating apparatus comprises one of a tankless water heater and a boiler.

12. A method for managing power of a hydraulic heating system comprising:
determining a desired outgoing water temperature supplied from the heating system;
setting a level at which the hydraulic heating system draws input power to obtain the outgoing water temperature; and
setting an output power level capacity based on the input power level.

13. The method of claim 12, comprising:
regulating the output power level capacity by a power control system of the hydraulic heating system.

14. The method of claim 13, wherein the power control system comprises one or more heating elements, and adjusting the capacity output from said one or more heating elements to regulate the output power level capacity.

15. The method of claim 12, comprising:
regulating the power control system by a control circuit of the hydraulic heating system.

16. The method of claim 12, comprising:
variably adjusting the level at which the hydraulic heating system draws input power.

17. A system for managing power of a hydraulic heating system comprising:
means for determining a desired outgoing water temperature supplied from the heating system;
means for setting a level at which the hydraulic heating system draws input power to obtain the outgoing water temperature; and
means for setting an output power level capacity based on the input power level.

18. The system of claim 17, wherein the means for setting a level at which the hydraulic heating system draws input power comprises a variable setting device.

19. The method of claim 17, further comprising:
means for regulating the output power level capacity of the hydraulic heating system.

20. The method of claim 19, wherein the regulating means comprises a power control system of the hydraulic heating system.
